(19) United States
(12) Patent Application Publication
(10) Pub. No.: US 2020/0036456 A1
(43) Pub. Date: Jan. 30, 2020

(54) HYBRID TECHNIQUES FOR INFORMATION TRANSFER USING DISCRETE-FREQUENCY SIGNALS AND INSTANTANEOUS FREQUENCY MEASUREMENT

(71) Applicant: ASTRONICS AEROSAT, Manchester, NH (US)

(72) Inventors: Richard P. Lizotte, Hudson, NH (US); Jonathan E. Epstein, Acton, MA (US); John M. Wilson, Hanover, NH (US)

(21) Appl. No.: 16/590,288

(22) Filed: Oct. 1, 2019

Related U.S. Application Data
(63) Continuation-in-part of application No. 16/226,412, filed on Dec. 19, 2018.
Application No. 16/226,412 is a continuation of application No. 16/126,361, filed on Sep. 10, 2018.
(60) Provisional application No. 62/557,418, filed on Sep. 12, 2017.

(51) Int. Cl. H04B 17/21; H04J 14/02; H04B 10/508; H04B 10/524; H04B 7/01; H04W 24/10; H04W 72/04

(52) U.S. Cl. CPC H04B 17/21; H04J 14/0227; H04B 10/508; H04W 72/0453; H04B 7/01; H04W 24/10; H04B 10/524

(57) ABSTRACT

A method includes receiving a first signal pulse and determining a first frequency band and a first value of a first signal property that are associated with the first signal pulse. The method includes, in accordance with a determination that the first frequency band is a respective frequency band in a first predefined set of frequency bands, determining first data that is associated with the first frequency band. The method includes, in accordance with a determination that the first value of the first signal property is a respective value in a first predefined set of values of the first signal property, determining second data that is associated with the first value of the first signal property. The first signal pulse represents the first data and the second data. The first predefined set of frequency bands, in aggregate, are not contiguous.

### RELATED APPLICATIONS

This application is a continuation-in-part of U.S. application Ser. No. 16/226,412, filed Dec. 19, 2018, entitled “Information Transfer Using Discrete-Frequency Signals and Instantaneous Frequency Measurement,” which is a continuation of U.S. application Ser. No. 16/126,361, filed Sep. 10, 2018, entitled “Information Transfer Using Discrete-Frequency Signals and Instantaneous Frequency Measurement,” which claims priority to U.S. Provisional Application Ser. No. 62/557,418, filed Sep. 12, 2017, entitled “Information Transfer Using Discrete-Frequency Continuous Waves and Instantaneous Frequency Measurement,” all of which are incorporated by reference herein in their entireties.

### TECHNICAL FIELD

This relates generally to information transfer through modulation of electronic signals, including but not limited to discrete-frequency signals and instantaneous frequency measurement of signals.

### BACKGROUND

The transfer of information between devices is widely achieved through the modulation and transmission of electronic signals, for example by a transmitter, and the receipt and demodulation of the transmitted electronic signals, for example by a receiver. Conventional techniques for modulation of electronic signals are cumbersome, inefficient, and limited. In some cases, conventional modulation methods are constrained by limited signal-to-noise ratios of transmitted signals, often due to limits on transmission power levels due to transmitter design or to regulatory limits. In some cases, conventional modulation methods require wide bands of frequency spectrum, which are limited and can be difficult to obtain. In some cases, because receivers have limited ability to accurately determine the frequency of a received signal, wider frequency bands are used for each unit of information, which reduces the information transmission rate obtainable per unit of a particular band of frequency spectrum.

### SUMMARY

Accordingly, there is a need for methods of information transfer, and systems and devices for carrying out such methods, that better utilize available frequency spectrum, improve receiver accuracy, and achieve higher rates of information transmission per unit of available frequency spectrum.

The above deficiencies and other problems associated with conventional information transfer approaches are reduced or eliminated by the disclosed methods, devices, and systems. In accordance with some embodiments, a method of transmitting information includes obtaining first data, from a first set of data, and second data, from a second set of data, for transmission. The method includes determining a first frequency band, in a first predefined set of frequency bands, that is associated with the first data. The method includes determining a first value of a first signal property, in a first predefined set of values of the first signal property, that is associated with the second data. The method includes transmitting a first signal pulse having a first frequency in the first frequency band and having the first value of the first signal property. The first signal pulse represents the first data and the second data. Each frequency band in the first predefined set of frequency bands is associated with distinct respective data from the first set of data. Each value of the first signal property in the first predefined set of values of the first signal property is associated with distinct respective data from the second set of data. The first predefined set of frequency bands, in aggregate, are not contiguous.

In some embodiments, the first data and the second data correspond to bits of data.

In some embodiments, the first set of data and the second set of data correspond to respective portions of a same predefined set of symbols.

In some embodiments, the first set of data corresponds to a first set of symbols and the second set of data corresponds to a second set of symbols distinct from the first set of symbols.

In some embodiments, the first signal property is phase.

In some embodiments, the first signal property is amplitude.

In some embodiments, the first signal property is pulse width.

In some embodiments, the method further comprises obtaining third data from a third set of data and determining a first value of a second signal property, in a second predefined set of values of the second signal property, that is associated with the third data. The transmitted first signal pulse has the first value of the second signal property. Each value of the second signal property in the second predefined set of values of the second signal property is associated with distinct respective data from the third set of data.

In some embodiments, the method further comprises obtaining fourth data from a fourth set of data and determining a first value of a third signal property in a third predefined set of values of the third signal property, that is associated with the fourth data. The transmitted first signal pulse has the first value of the third signal property. Each value of the third signal property in the third predefined set of values of the third signal property is associated with distinct respective data from the fourth set of data.

In some embodiments, the first signal property, the second signal property and the third signal property are distinct signal properties.

In some embodiments, each respective data in the first set of data is associated with only one respective frequency band in the first predefined set of frequency bands, and each respective data in the second set of data is associated with only one respective value in the first predefined set of values of the first signal property.

In some embodiments, the method further comprises obtaining fifth data from the first set of data and sixth data from the second set of data for transmission. The fifth data is the same as the first data and the sixth data is distinct from the second data. The method further comprises determining a second frequency band, in the first predefined set of frequency bands, that is associated with the fifth data. The second frequency band is the same as the first frequency band. The method further comprises determining a second value of the first signal property, in the first predefined set of values of the first signal property, that is associated with the sixth data. The second value of the first signal property is distinct from the first value of the first signal property. The method further comprises, after at least a predefined amount of time since transmitting the first signal pulse, transmitting a second signal pulse having the second value of the first signal property and having a respective frequency in the first frequency band.

In accordance with some embodiments, a system for information transfer includes processing circuitry configured to obtain first data from a first set of data and second data from a second set of data for transmission, and to determine a first frequency band, in a first predefined set of frequency bands, that is associated with the first data, and determine a first value of a first signal property, in a first predefined set of values of the first signal property, that is associated with the second data. The system includes a transmitter, configured to transmit a first signal pulse having a first frequency in the first frequency band and having the first value of the first signal property. The first signal pulse represents the first data and the second data. Each frequency band in the predefined set of frequency bands is associated with distinct respective data from the first set of data. Each value of the first signal property in the first predefined set of values of the first signal property is associated with distinct respective data from the second set of data. The predefined set of frequency bands, in aggregate, are not contiguous. In some embodiments, the system for information transfer is configured to perform any of the methods for transmitting information, as described herein.

In accordance with some embodiments, a method of receiving information includes receiving a first signal pulse. The method includes determining a first frequency band that is associated with the first signal pulse and determining a first value of a first signal property that is associated with the first signal pulse. The method includes, in accordance with a determination that the first frequency band is a respective frequency band in a first predefined set of frequency bands, determining first data, from a first set of data, that is associated with the first frequency band and represented by the first signal pulse. The method includes, in accordance with a determination that the first value of the first signal property is a respective value in a first predefined set of values of the first signal property, determining second data, from a second set of data, that is associated with the first value of the first signal property and represented by the first signal pulse. The first signal pulse represents the first data and the second data. Each frequency band in the predefined set of frequency bands is associated with distinct respective data from the first set of data. Each value of the first signal property in the first predefined set of values of the first signal property is associated with distinct respective data from the second set of data. The first predefined set of frequency bands, in aggregate, are not contiguous.

In some embodiments, the first data and the second data correspond to bits of data.

In some embodiments, the first set of data and the second set of data correspond to respective portions of a same predefined set of symbols.

In some embodiments, the first set of data corresponds to a first set of symbols and the second set of data corresponds to a second set of symbols distinct from the first set of symbols.

In some embodiments, the first signal property is phase.

In some embodiments, the first signal property is amplitude.

In some embodiments, the first signal property is pulse width.

In some embodiments, the method further comprises determining a value of a second signal property that is associated with the first signal pulse. The method includes, in accordance with a determination that the value of the second signal property is a respective value in a second predefined set of values of the second signal property, determining third data, from a third set of data, that is associated with the value of the second signal property and represented by the first signal pulse. Each value of the second signal property in the second predefined set of values of the second signal property is associated with distinct respective data from the third set of data.

In some embodiments, the method includes determining a value of a third signal property that is associated with the first signal pulse. The method includes, in accordance with a determination that the value of the third signal property is a respective value in a third predefined set of values of the third signal property, determining fourth data, from a fourth set of data, that is associated with the value of the third signal property and represented by the first signal pulse. Each value of the third signal property in the third predefined set of values of the third signal property is associated with distinct respective data from the fourth set of data.

In some embodiments, the first signal property, the second signal property and the third signal property are distinct signal properties.

In some embodiments, each respective data in the first set of data is associated with only one respective frequency band in the first predefined set of frequency bands, and each respective data in the second set of data is associated with only one respective value in the first predefined set of values of the first signal property.

In some embodiments, the method includes, after at least a predefined amount of time since receiving the first signal pulse, receiving a second signal pulse. The method includes determining a second frequency band that is associated with the second signal pulse and determining a second value of the first signal property that is associated with the second signal pulse. The method includes, in accordance with a determination that the second frequency band is the respective frequency band in the first predefined set of frequency bands, determining fifth data, from the first set of data, that is associated with the second frequency band and represented by the second signal pulse. The fifth data is the same as the first data. The method includes, in accordance with a determination that the second value of the first signal property is a respective value in the first predefined set of values of the first signal property, determining sixth data, from the second set of data, that is associated with the second value of the first signal property and represented by the second signal pulse, wherein the sixth data is distinct from the second data.

In accordance with some embodiments, a system for information transfer includes a receiver configured to receive a first signal pulse. The system further includes frequency determination circuitry, configured to determine a first frequency band that is associated with the first signal pulse. The system further includes first signal property determination circuitry, configured to determine a first value of a first signal property that is associated with the first signal pulse. The system includes processing circuitry, configured to, in accordance with a determination that the first frequency band is a respective frequency band in a first predefined set of frequency bands, determine first data, from a first set of data, that is associated with the first frequency band and represented by the first signal pulse. The processing circuitry is further configured to, in accordance with a determination that the first value of the first signal property is a respective value in a first predefined set of values of the first signal property, determine second data, from a second set of data, that is associated with the first value of the first signal property and represented by the first signal pulse. The first signal pulse represents the first data and the second data. Each frequency band in the predefined set of frequency bands is associated with distinct respective data from the first set of data. Each value of the first signal property in the first predefined set of values of the first signal property is associated with distinct respective data from the second set of data. The predefined set of frequency bands, in aggregate, are not contiguous. In some embodiments, the system for information transfer is configured to perform any of the methods for receiving information, as described herein.

### BRIEF DESCRIPTION OF THE DRAWINGS

For a better understanding of the various described embodiments, reference should be made to the Detailed Description below, in conjunction with the following drawings.

FIG. 1 is a block diagram illustrating an example implementation of a communications system, in accordance with some embodiments.

FIG. 2A is a block diagram illustrating an example implementation of a transmitting system, in accordance with some embodiments.

FIG. 2B is a block diagram illustrating an example implementation of a receiving system, in accordance with some embodiments.

FIGS. 3A-3B are block diagrams illustrating example lookup tables assigning signal properties to symbols and symbol data, in accordance with some embodiments.

FIG. 3C is a conceptual diagram showing example allocations of a frequency spectrum, in accordance with some embodiments.

FIG. 3D illustrates an example sequence of discrete-frequency signals, in accordance with some embodiments.

FIG. 3E illustrates example variations in signal properties for representing multiple symbols using a given frequency.

FIG. 4 is a block diagram illustrating an example implementation of frequency detection circuitry, in accordance with some embodiments.

FIGS. 5A-5C are flow diagrams illustrating an example method of receiving information, in accordance with some embodiments.

FIGS. 6A-6C are flow diagrams illustrating an example method of transmitting information, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all the elements of a given system, method or device, or may depict relevant features or portions of an element without depicting the full extent of the element. Finally, like reference numerals refer to corresponding parts throughout the several views of the drawings.

### DETAILED DESCRIPTION

Reference will now be made in detail to embodiments, examples of which are illustrated in the accompanying drawings. In the following detailed description, numerous specific details are set forth to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms “first,” “second,” etc. may be used herein to describe various elements, these elements should not be limited by these terms. These terms are only used to distinguish one element from another. For example, a first signal could be termed a second signal, and, similarly, a second signal could be termed a first signal, without changing the meaning of the description, so long as all occurrences of the “first signal” are renamed consistently and all occurrences of the “second signal” are renamed consistently. The first signal and the second signal are both signals, but they are not the same signal, unless the context clearly indicates otherwise.

The terminology used herein is for the purpose of describing particular embodiments only and is not intended to be limiting of the claims. As used in the description of the embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the phrase “at least one of A, B and C” is to be construed to require one or more of the listed items, and this phrase reads on a single instance of A alone, a single instance of B alone, or a single instance of C alone, while also encompassing combinations of the listed items such as “one or more of A and one or more of B without any of C,” and the like.

As used herein, the term “if” may be construed to mean “when” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

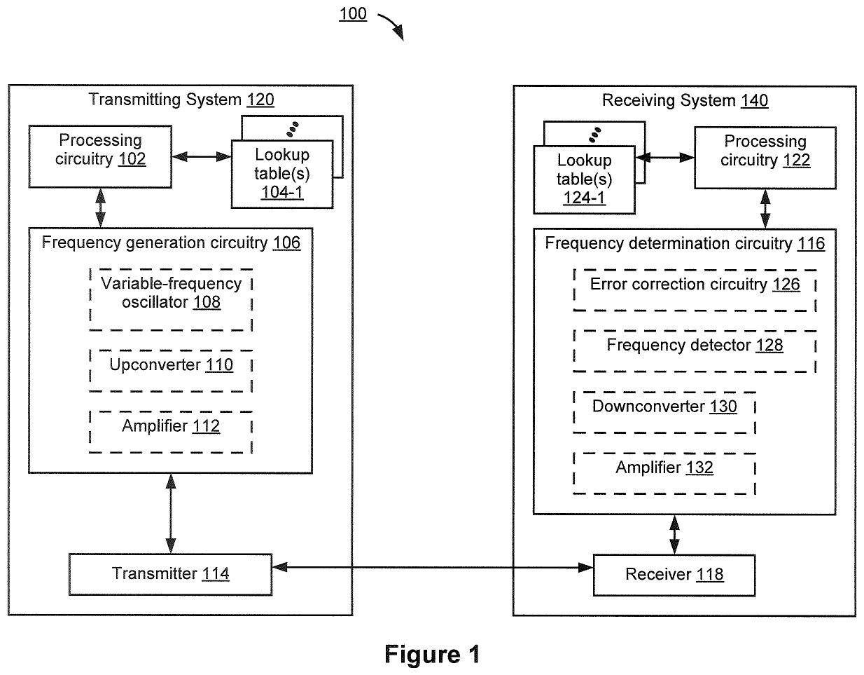

FIG. 1 is a block diagram illustrating an example implementation of communications system 100, in accordance with some embodiments. In some embodiments, communications system 100 is used to perform any of the methods described herein. While some example features are illustrated, various other features have not been illustrated for the sake of brevity and so as not to obscure pertinent aspects of the example embodiments disclosed herein. To that end, as a non-limiting example, communications system 100 includes a transmitting system 120 (sometimes called a transmitting device), which is used to transmit data (e.g., to a receiving system), and a receiving system 140 (sometimes called a receiving device), which is used to receive data (e.g., transmitted by a transmitting system).

In some embodiments, transmitting system 120 includes processing circuitry 102. In some embodiments, processing circuitry 102 is implemented using one or more processors (or processor cores) (e.g., CPUs, microprocessors, microcontrollers, digital signal processors (DSPs), or the like) configured to execute instructions in one or more programs (e.g., stored in processing circuitry 102, such as in one or more memory components of processing circuitry 102, or stored in memory separate from and communicatively coupled with processing circuitry 102) for performing operations described herein. In some embodiments, processing circuitry 102 is implemented using hardware circuitry such as one or more field-programmable gate arrays (FPGAs) or application-specific integrated circuits (ASICs) configured to perform operations described herein.

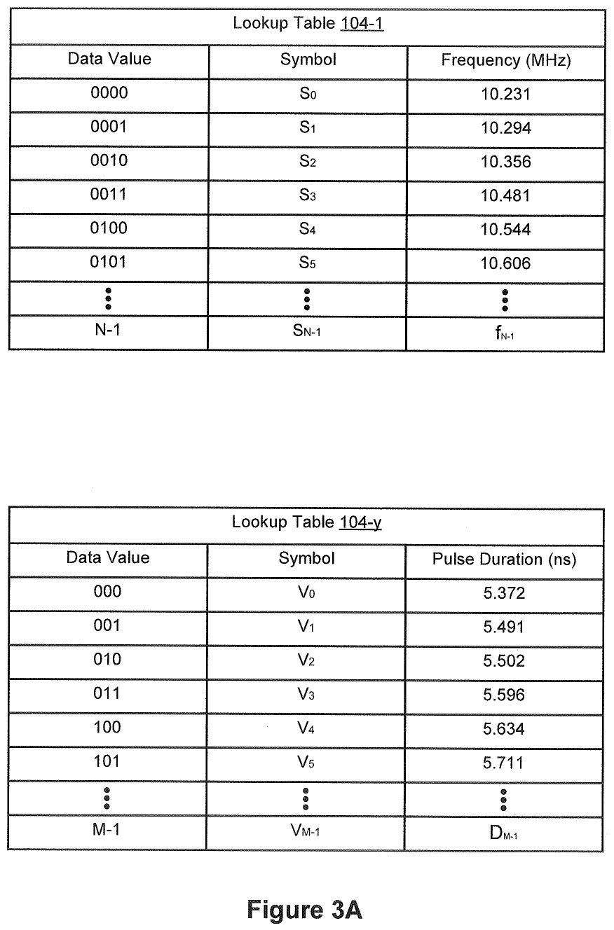

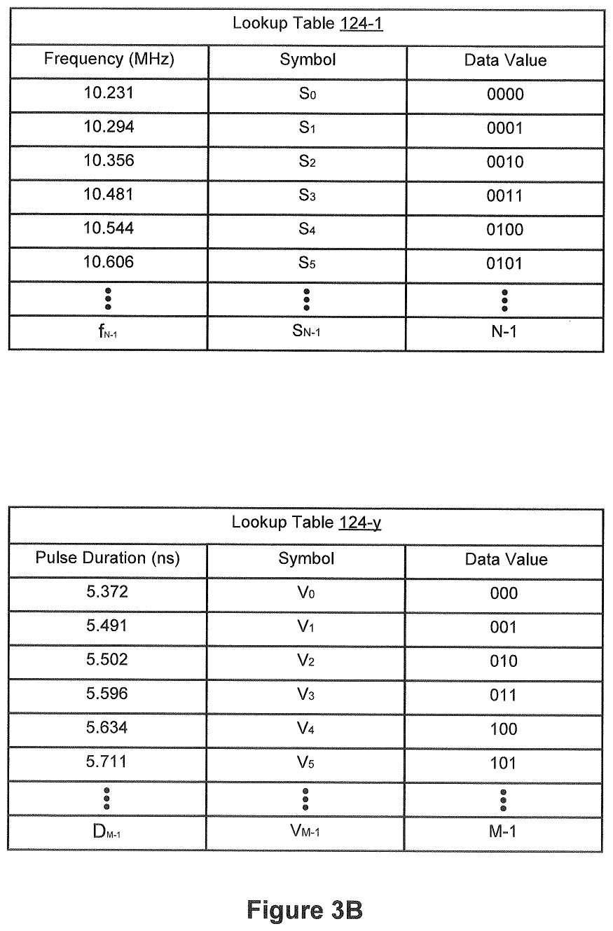

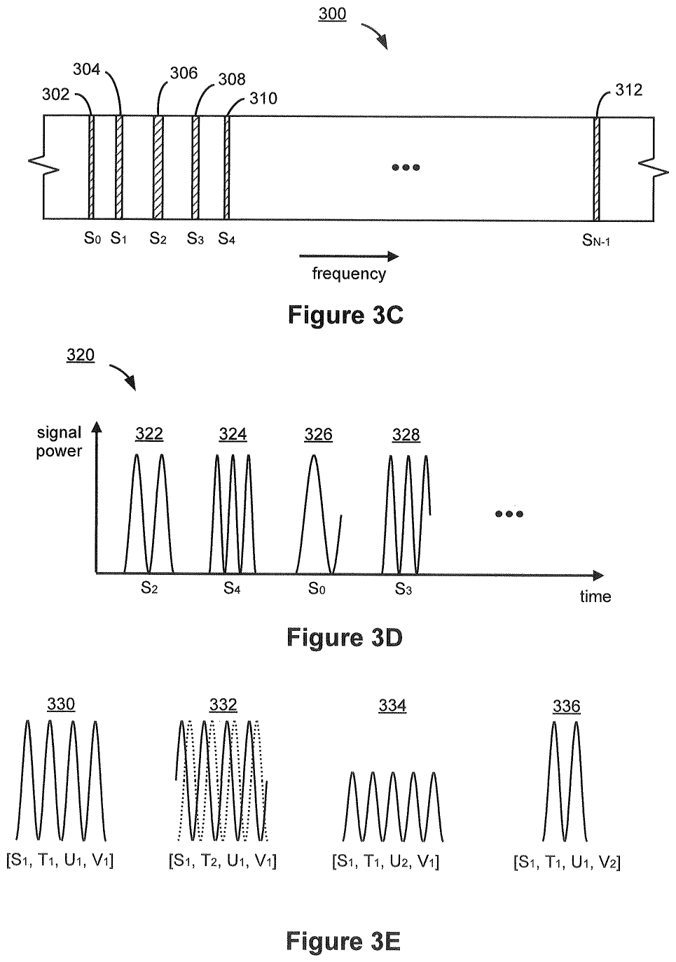

In some embodiments, transmitting system 120 includes lookup table(s) 104 (e.g., lookup table 104-1 to lookup table 104-y, where y is an integer). In some embodiments, the information stored in lookup tables 104-1 to 104-y are combined into a single lookup table (e.g., stored in a same data structure). In some embodiments, transmitting system 120 includes other lookup table(s) in addition to lookup tables 104-1 and 104-y (e.g., where each table at the transmitting system stores symbol data and/or symbols associated with values of a respective signal property). In some embodiments, lookup table 104-1 stores information associating symbols (which represent units of data) with frequencies representing the symbols, and, in some embodiments, associating units of data with the symbols representing the data (e.g., as described in further detail herein with reference to FIG. 3A). In some embodiments, lookup table 104-y stores information associating symbols with values of a signal property (e.g., an amplitude of the signal, a phase of the signal, or a pulse width). In some embodiments, processing circuitry 102 is communicatively coupled with lookup table(s) 104. In some embodiments, the lookup table(s) are stored in a storage medium, such as non-volatile memory (e.g., solid-state memory, flash memory, that can be part of or separate from processing circuitry 102) or volatile memory (e.g., a cache of processing circuitry 102) in transmitting system 120. In some embodiments, processing circuitry 102 identifies data for transmission, and, using information from lookup table(s) 104, identifies from the data one or more units of data for transmission (e.g., one or more groups of bits of data) corresponding to one or more predefined symbols. In some embodiments, processing circuitry 102 uses information obtained from lookup table(s) 104 to determine respective frequencies and respective values of signal properties (e.g., other than frequency) at which to transmit respective signals representing the one or more symbols, each representing a unit of the data for transmission.

In some embodiments, transmitting system 120 includes frequency generation circuitry 106. In some embodiments, frequency generation circuitry 106 is used to generate respective signals at respective frequencies determined by processing circuitry 102, to represent one or more symbols representing data. To that end, in some embodiments, frequency generation circuitry 106 includes variable-frequency oscillator (VFO) 108, upconverter 110, and/or amplifier 112. In some embodiments, VFO 108 is used to generate signals (e.g., continuous wave signals or pulses) at respective frequencies. In some embodiments, VFO 108 generates sinusoidal signals. In some embodiments, VFO 108 generates square waves. In some embodiments, VFO 108 generates signals that have frequencies corresponding to the frequencies in lookup table 104-1 and are representative of symbols. In some embodiments, the signals generated by VFO 108 are optionally converted to higher frequencies for transmission using upconverter 110 (e.g., in situations where higher-frequency signal transmission is preferred over lower-frequency signal transmission). In some embodiments, amplifier 112 receives signals from frequency generation circuitry 106, optionally via upconverter 110, and amplifies the signals (e.g., the signal amplitude) prior to transmission.

In some embodiments, transmitting system 120 includes transmitter 114. In some embodiments, transmitter 114 is used to transmit signals that have been produced by frequency generation circuitry 106 (optionally in conjunction with upconverter 110 and/or amplifier 112) in accordance with respective frequencies determined by processing circuitry 102, and optionally amplified using amplifier 112. In some embodiments, transmitter 114 is, or includes, an antenna.

In some embodiments, one or more signals transmitted by transmitting system 120 (e.g., by transmitter 114), are received at receiving system 140. More specifically, in some embodiments, the one or more signals are received at receiver 118 of receiving system 140. In some embodiments, receiver 118 is, or includes, an antenna. In some embodiments, receiver 118 is communicatively coupled with frequency determination circuitry 116. In some embodiments, frequency determination circuitry 116 determines respective frequencies of one or more signals received by receiver 118 (e.g., from transmitting system 120).

In some embodiments, frequency determination circuitry 116 includes amplifier 132, downconverter 130, frequency detector 128, and/or error correction circuitry 126. In some embodiments, signals received by receiver 118 are amplified by amplifier 132 prior to determining the frequencies of the received signals. In some embodiments, such as those in which a transmitting system uses an upconverter, corresponding downconverter 130 is used to convert received signals to signals that have lower frequencies, which in turn are used for detection and decoding. In some embodiments, frequency detector 128 receives signals from receiver 118 (optionally via downconverter 130 and/or amplifier 132) and determines the frequencies of the received signals.

In some embodiments, error correction circuitry 126 receives detected frequencies from frequency detector 128 and determines a correction factor (e.g., an offset) corresponding to the determined frequencies. In some embodiments, error correction circuitry 126 is used to calibrate or recalibrate frequency detector 128. In some such embodiments, error correction circuitry 126 compares a detected frequency received from frequency detector 128 to a known, expected frequency, to determine a correction factor for the determined frequency. In some embodiments, error correction circuitry 126 is used to correct a detected frequency by applying a previously-determined correction factor to a detected frequency received from frequency detector 128.

In some embodiments, frequency determination circuitry 116 (e.g., frequency detector 128, optionally in conjunction with error correction circuitry 126) outputs frequencies that have been determined for received signals to processing circuitry 122 of receiving system 140. In some embodiments, processing circuitry 122 is implemented using one or more processors configured to execute instructions in one or more programs, or using hardware circuitry, as described above with reference to processing circuitry 102 of transmitting system 120.

In some embodiments, receiving system 140 includes lookup table(s) 124 (e.g., lookup table 124-1 to lookup table 124-y, where y is an integer). In some embodiments, receiving system 140 includes lookup table(s) distinct from the lookup table(s) of transmitting system 120. For example, lookup table 104-1 of transmitting system 120 associates respective data values with respective symbols and respective frequencies, and is used by transmitting system 120 to determine a frequency at which to transmit a signal pulse representing a particular symbol, and lookup table 124-1 of receiving system 140 associates respective frequencies with respective symbols and respective data values, and is used by receiving system 140 to identify a particular data value or symbol represented by a received signal pulse based on the frequency of the received signal pulse. In some embodiments, the information stored in lookup tables 124-1 to 124-y are combined into a single lookup table. In some embodiments, the lookup table(s) 124 of the receiving system store information associating symbols (which represent units of data) with values of signal properties representing the symbols, and, in some embodiments, associating units of data with the symbols representing the data (e.g., as described in further detail herein with reference to FIG. 3B). In some embodiments, processing circuitry 122 is communicatively coupled with lookup table(s) 124. In some embodiments, lookup table(s) 124 are stored in a storage medium, such as non-volatile memory (e.g., solid-state memory, flash memory, that can be part of or separate from processing circuitry 122) or volatile memory (e.g., a cache of processing circuitry 122) in receiving system 140. In some embodiments, processing circuitry 122 uses information from lookup table(s) 124 to determine respective symbols associated with respective frequencies received from frequency determination circuitry 116 (e.g., respective frequencies of signals received at receiver 118). In some embodiments, processing circuitry 122 uses information from lookup table(s) 124 to identify one or more units of received data represented by the determined symbols. In some embodiments, processing circuitry 122 processes the one or more units of received data. In some embodiments, processing circuitry 122 aggregates (e.g., concatenates) multiple units of received data and processes the aggregated data.

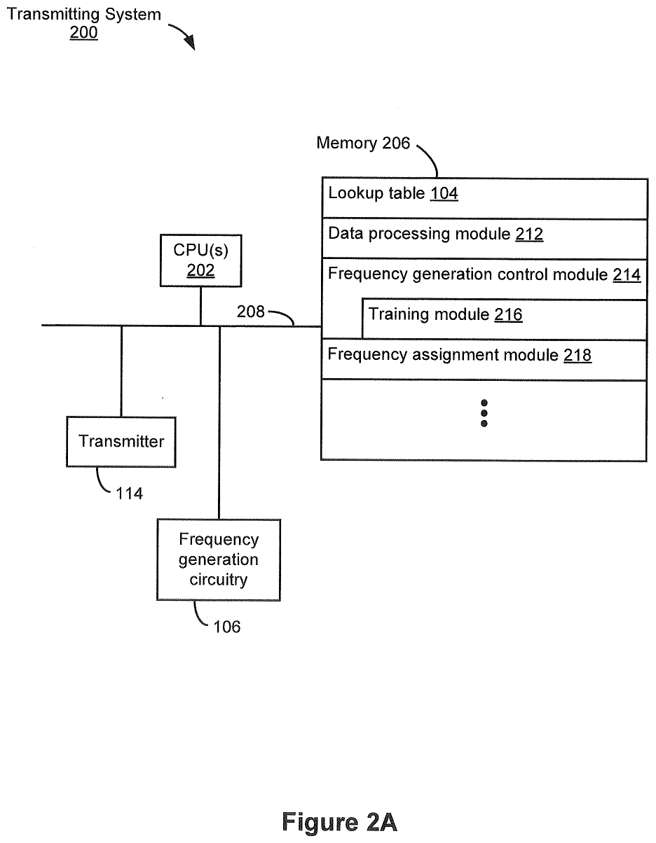

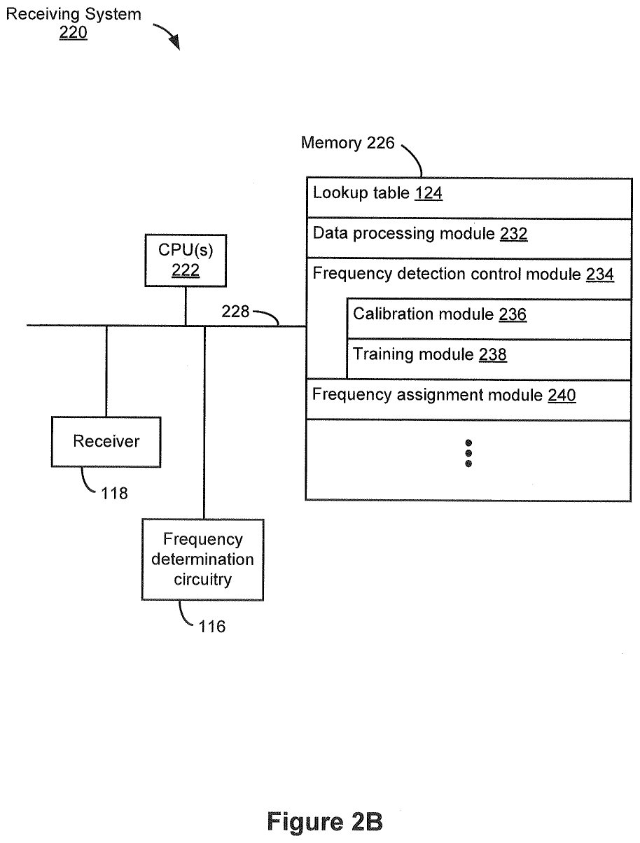

FIG. 2A is a block diagram illustrating an example implementation of a transmitting system 200, in accordance with some embodiments. In some embodiments, transmitting system 200 is used in communication system 100, FIG. 1 (e.g., in place of transmitting system 120) for transmitting signals representing data (e.g., information for transmission).

In some embodiments, transmitting system 200 includes one or more processing units 202 (e.g., sometimes called processors or CPUs, and implemented using processors or processing cores, as described above) for executing modules, programs, and/or instructions stored in memory 206 for performing operations described herein; memory 206; and one or more communication buses 208 for interconnecting these components. Communication buses 208 optionally include circuitry (sometimes called a chipset) that interconnects and controls communications between system components. In some embodiments, transmitting system 200 includes transmitter 114 and frequency generation circuitry 106 (e.g., as described herein with reference to FIG. 1).

In some embodiments, memory 206 includes high-speed random access memory, such as DRAM, SRAM, DDR RAM, or other random access solid state memory devices, and may include non-volatile memory, such as one or more magnetic disk storage devices, optical disk storage devices, flash memory devices, or other non-volatile solid state storage devices. Memory 206 optionally includes one or more storage devices remotely located from processors 202. In some embodiments, memory 206, or the non-volatile memory device(s) within memory 206, includes a non-transitory computer readable storage medium. In some embodiments, memory 206, or the computer readable storage medium of memory 206, stores the following programs, modules, and data structures, or a subset or superset thereof:
lookup table(s) 104, used for storing associations of units of data to symbols and frequencies and/or other signal properties (e.g., as described herein with reference to FIG. 1);
data processing module 212, used for identifying units of data from aggregated data, identifying symbols associated with the identified units of data, and identifying frequencies representing the identified symbols and identified units of data;
frequency generation control module 214, used for controlling generation of signals at identified frequencies (e.g., identified by data processing module 212) using frequency generation circuitry 106, optionally including:
   training module 216, used for controlling generation of one or more calibration signals (sometimes called a “training sequence”) for transmission to a receiving system and used to correct for or mitigate transmission errors between transmitting system 200 and the receiving system; and
frequency assignment module 218, used for identifying frequencies and/or frequency bands that are available for transmission, and assigning units of data and symbols to a set of frequency bands (or to respective frequencies within the set of frequency bands), and, in some embodiments, reassigning units of data and symbols to different sets of frequency bands (or frequencies), and for updating lookup table(s) 104 accordingly.

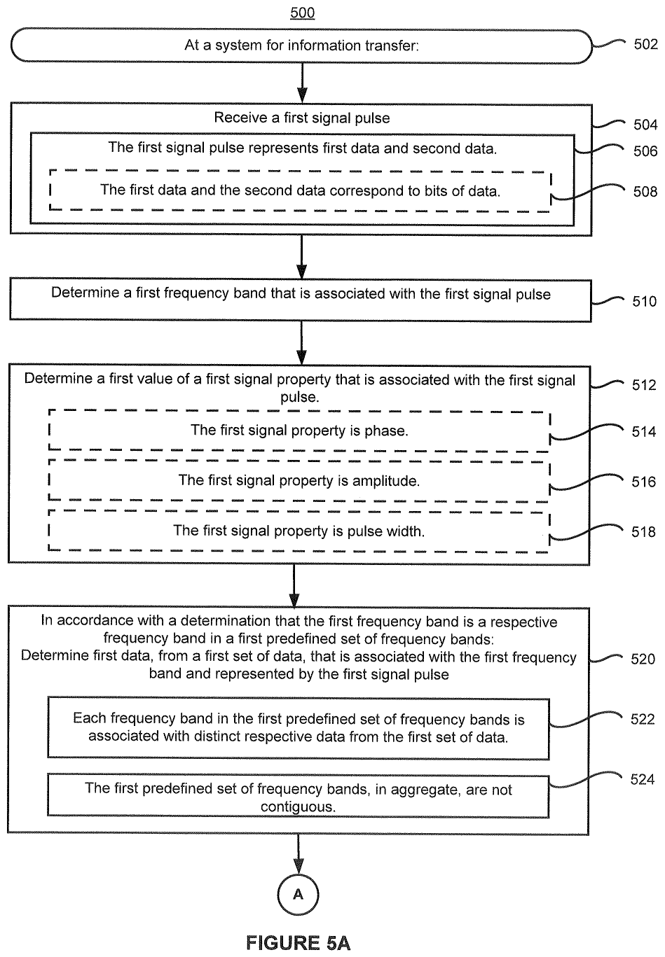

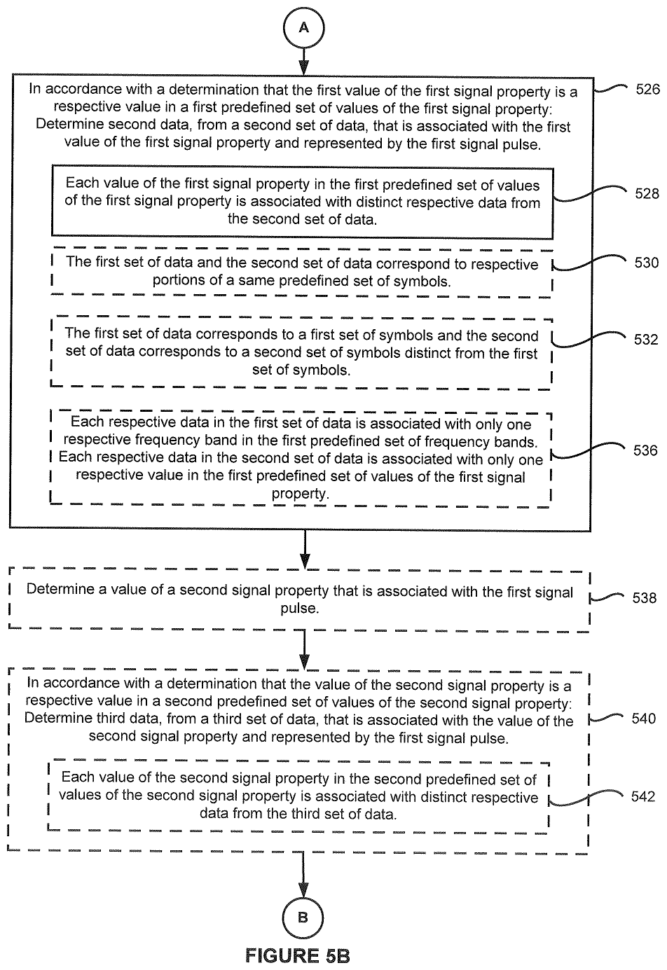

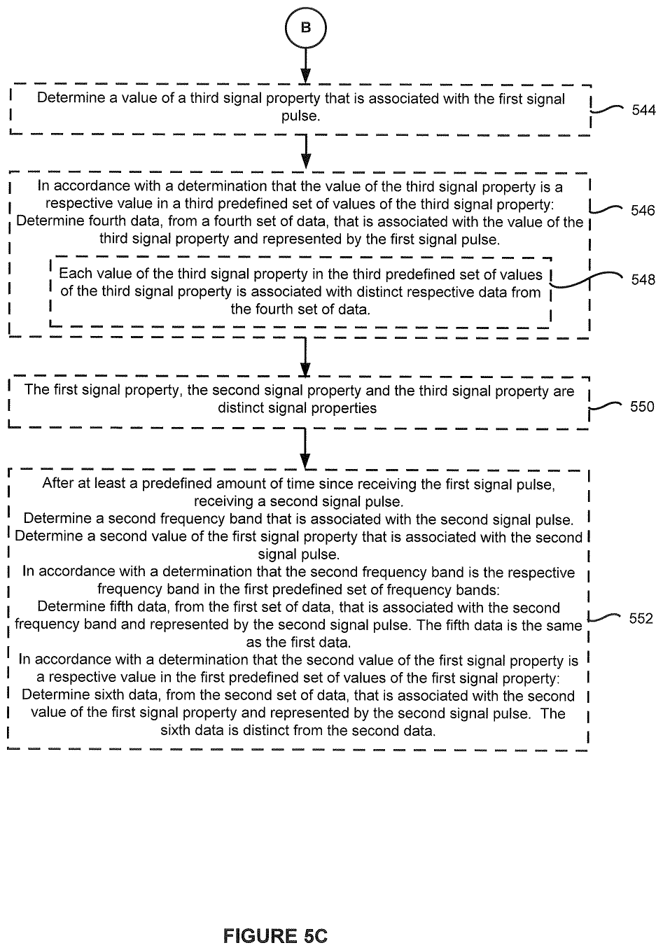

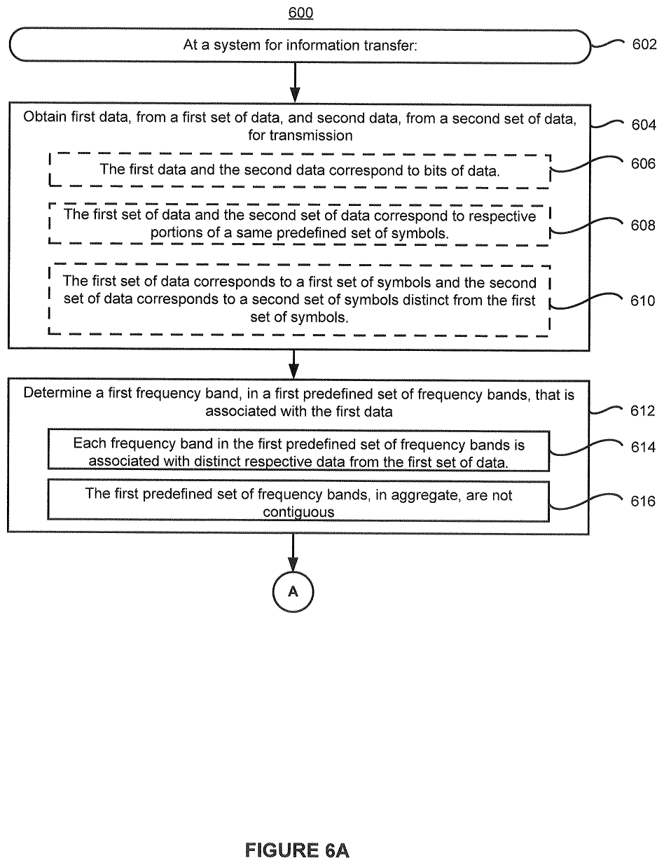

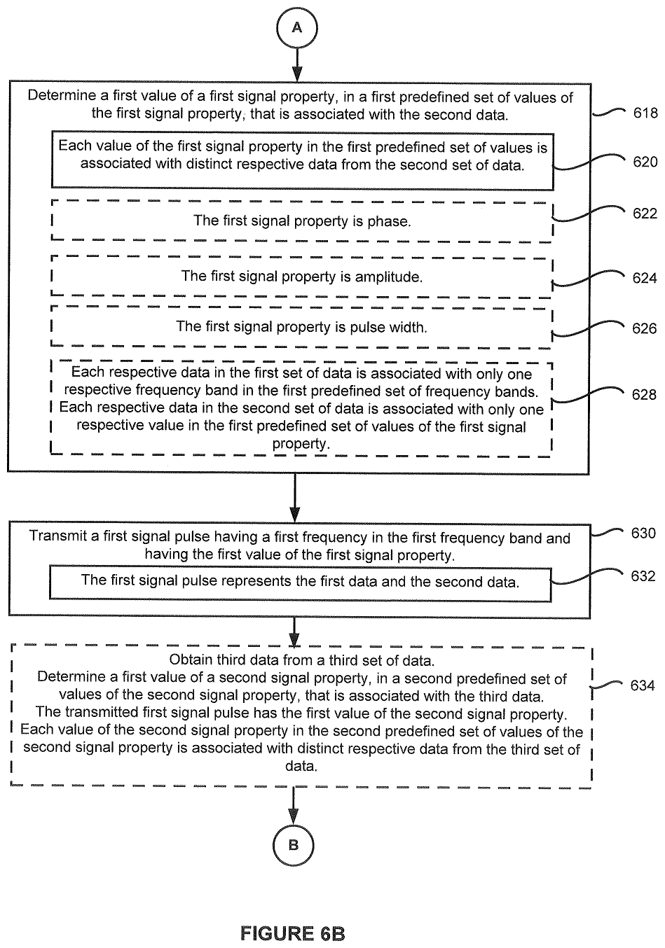

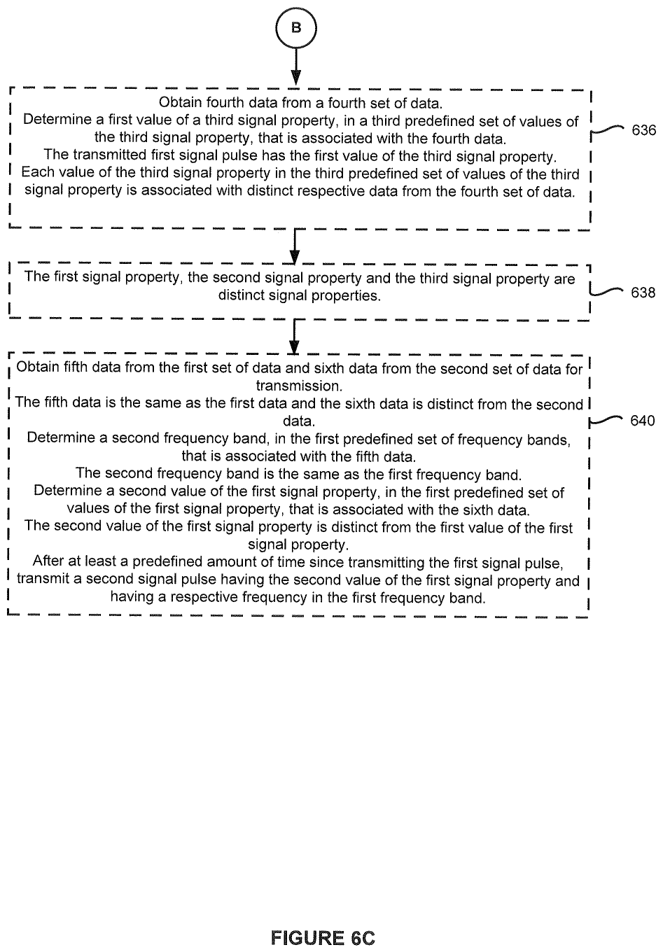

Each of the above identified elements may be stored in one or more of the previously mentioned memory devices that together form memory 206, and corresponds to one or more sets of instructions for performing a function described above. The above identified modules or programs (i.e., sets of instructions) need not be implemented as separate software programs, procedures, or modules, and thus various subsets of these modules may be combined or otherwise rearranged in various embodiments. In some embodiments, memory 206 may store a subset of the modules and data structures identified above. In some embodiments, memory 206 may store additional modules and data structures not described above. In some embodiments, the programs, modules, and data structures stored in memory 206, or the computer readable storage medium of memory 206, provide instructions for implementing respective operations in the methods described below with reference to FIGS. 5A-5C and 6A-6C.

Although FIG. 2A shows transmitting system 200, FIG. 2A is intended more as a functional description of the various features that may be present in a transmitting system than as a structural schematic of the embodiments described herein. In practice, and as recognized by those of ordinary skill in the art, items shown separately could be combined and some items could be separated. Further, in some embodiments, one or more modules of transmitting system 200 are implemented in transmitting system 120 (e.g., in processing circuitry 102) of FIG. 1.

FIG. 2B is a block diagram illustrating an example implementation of a receiving system 220, in accordance with some embodiments. In some embodiments, receiving system 220 is used in communication system 100, FIG. 1 (e.g., in place of receiving system 140) for receiving signals representing data (e.g., transmitted information).

In some embodiments, receiving system 220 includes one or more processing units 222 (e.g., sometimes called processors or CPUs, and implemented using processors or processing cores, as described above) for executing modules, programs, and/or instructions stored in memory 226 for performing operations described herein; memory 226; and one or more communication buses 228 for interconnecting these components. Communication buses 228 optionally include circuitry (sometimes called a chipset) that interconnects and controls communications between system components. In some embodiments, receiving system 220 includes receiver 118 and frequency determination circuitry 116 (e.g., as described herein with reference to FIG. 1).

In some embodiments, memory 226 includes high-speed random access memory, such as DRAM, SRAM, DDR RAM, or other random access solid state memory devices, and may include non-volatile memory, such as one or more magnetic disk storage devices, optical disk storage devices, flash memory devices, or other non-volatile solid state storage devices. Memory 226 optionally includes one or more storage devices remotely located from processors 222. In some embodiments, memory 226, or the non-volatile memory device(s) within memory 226, includes a non-transitory computer readable storage medium. In some embodiments, memory 226, or the computer readable storage medium of memory 226, stores the following programs, modules, and data structures, or a subset or superset thereof:
lookup table(s) 124, used for storing associations of units of data to symbols and frequencies and/or other signal properties (e.g., as described herein with reference to FIG. 1);
data processing module 232, used for identifying symbols represented by detected frequencies, identifying units of data represented by the identified symbols, and aggregating the units of data for processing;
frequency detection control module 234, used for controlling frequency determination circuitry 116 to detect frequencies of received signals (e.g., from receiver 118), optionally including:
   calibration module 236, used for controlling, generating, and processing signals used for internal calibration of frequency determination circuitry 116 (e.g., used local calibration of receiving system 220); and
   training module 238, used for processing one or more calibration signals (sometimes called a “training sequence”) received from a transmitting system and used to correct for or mitigate transmission errors between the transmitting system and receiving system 220.
frequency assignment module 240, used for updating lookup table(s) 124 with updated assignments of units of data and symbols to a different set of frequency bands (or to respective frequencies within the set of frequency bands) received from a transmitting system.

Each of the above identified elements may be stored in one or more of the previously mentioned memory devices that together form memory 226, and corresponds to one or more sets of instructions for performing a function described above. The above identified modules or programs (i.e., sets of instructions) need not be implemented as separate software programs, procedures, or modules, and thus various subsets of these modules may be combined or otherwise rearranged in various embodiments. In some embodiments, memory 226 may store a subset of the modules and data structures identified above. In some embodiments, memory 226 may store additional modules and data structures not described above. In some embodiments, the programs, modules, and data structures stored in memory 226, or the computer readable storage medium of memory 226, provide instructions for implementing respective operations in the methods described below with reference to FIGS. 5A-5C and 6A-6C.

Although FIG. 2B shows receiving system 220, FIG. 2B is intended more as a functional description of the various features that may be present in a receiving system than as a structural schematic of the embodiments described herein. In practice, and as recognized by those of ordinary skill in the art, items shown separately could be combined and some items could be separated. Further, in some embodiments, one or more modules of receiving system 220 are implemented in receiving system 140 (e.g., in processing circuitry 122) of FIG. 1.

FIGS. 3A-3B are block diagrams illustrating example lookup tables assigning signal properties to symbols and data values, in accordance with some embodiments. In particular, FIG. 3A illustrates example lookup tables 104-1 and 104-y for use in a transmitting system (e.g., transmitting system 120, FIG. 1, or transmitting system 200, FIG. 2A).

Lookup table 104-1 assigns respective data values in a first set of data values (e.g., each data value representing four bits of information, such as the data values 0000, 0001, 0010, etc.) to respective symbols in a first set of N symbols (e.g., symbols S₀ through S_{N-1}). In some embodiments, each data value in the first set of data values corresponds to a distinct symbol in the first set of symbols S. Each data value (and associated symbol) is associated with a respective signal property (e.g., frequency). As shown in FIG. 3A, each data value and associated symbol in lookup table 104-1 is associated with a nominal center frequency in a frequency band that is 62.5 kHz wide. It is noted that the frequency band for symbol S₁ and the frequency band for symbol S₂ are not contiguous. That is, the nominal center frequency of the frequency band immediately adjacent to and above the frequency band for symbol S₂ is 10.419 kHz, but this frequency is not assigned to any of the N symbols in symbol set S (or to any of the data values in the first set). Accordingly, in some embodiments, as in the example shown in FIG. 3A, the assigned frequency bands, in aggregate, are not contiguous. In some embodiments, the assigned frequency bands are contiguous. In some embodiments, some of the assigned frequency bands are contiguous (e.g., at least one subset of two or more assigned frequency bands are contiguous). In some embodiments, lookup table 104-1 is used by a transmitting system to identify, from data for transmission, the first data values (e.g., the four-bit data values 0000, 0001, etc.) and, in turn, frequencies representing the first data values.

Lookup table 104-y assigns respective data values (e.g., each data value representing three bits of information, such as the data values 000, 001, 010, etc.) in a second set of data values (e.g., distinct from the first set of data values in lookup table 104-1) to respective symbols in a second set of M symbols (e.g., symbols V₀ through V_{M-1}). Each of the symbols Vᵢ corresponds to a respective value of a signal property (e.g., distinct from the signal property stored by lookup table 104-1) for use in the transmitting system. In some embodiments, the second set of data values is distinct from the first set of data values. In some embodiments, the set of first symbols (e.g., S₀-S_{N-1}) and the set of second symbols (e.g., V₀-V_{M-1}) are distinct. In some embodiments, the second set of data is the same as the first set of data. In some embodiments, the set of first symbols and the set of second symbols are the same (e.g., or at least partially overlap).

Each set of symbols is associated with a respective signal property. For example, lookup table 104-1 of FIG. 3A illustrates that the set of symbols S (e.g., symbols S₀-S_{N-1}) is associated with frequency. Lookup table 104-y of FIG. 3A illustrates that the set of symbols V (e.g., symbols V₀-V_{M-1}) is associated with pulse duration. In some embodiments, the signal property is selected from the group consisting of phase, amplitude, and pulse duration (also called “pulse width”). In some embodiments, the transmitting system transmits a signal pulse having signal properties represented in lookup table(s) 104, such as a frequency corresponding to a first data value from lookup table 104-1 and a pulse duration (e.g., or other signal property) corresponding to a second data value from lookup table 104-y. As illustrated in FIG. 3B, the receiving system receives the transmitted signal pulse and, using the lookup table(s) 124, is enabled to identify, based on the signal properties of the received signal pulse, one or more data values represented by the signal pulse sent from (e.g., and encoded by) the transmitting system.

In some embodiments, additional lookup table(s) 104 are used in the transmitting system (e.g., in addition to lookup tables 104-1 and 104-y). For example, a lookup table 104-2 assigns a third set of data values (e.g., one or more bits of information) to another signal property (e.g., phase) that is distinct from the signal properties represented by lookup tables 104-1 and 104-y (e.g., frequency and pulse duration, respectively). In some embodiments, a lookup table 104-3 assigns a fourth set of data values (e.g., one or more bits of information) to another signal property (e.g., amplitude) that is distinct from the first, second, and third signal properties (e.g., frequency, pulse duration, and phase, respectively) is used in the transmitting system. In some embodiments, any combination of the lookup table(s) 104 are used by the transmitting system (e.g., to identify one or more of the signal properties, associated with respective sets of data values, to use to transmit a signal pulse).

In some embodiments, as shown in FIG. 3B, analogous lookup table(s) (e.g., lookup table(s) 124-1 and 124-y) are used in a receiving system (e.g., receiving system 140, FIG. 1, or receiving system 220, FIG. 2B). For example, lookup table(s) 124 in the receiving system correspond to lookup table(s) 104 in the transmitting system. The receiving system associates, using lookup table(s) 124, a respective value of a signal property with a respective data value, similar to how the transmitting system associates, using lookup table(s) 104, the respective data value with the respective value of the signal property.

In some embodiments, symbols in the first set of N symbols (e.g., associated with respective data values in the predefined first set of N data values, as shown in lookup table 104-1, FIG. 3A) need not be assigned to frequency bands in order. For example, although FIG. 3C (described in further detail herein) shows symbol S₀ assigned to a lower frequency band than the frequency band to which S₁ is assigned, and S_{N-1} assigned to the highest frequency band, in some cases a respective symbol Sᵢ may be assigned to a higher frequency band than the frequency band to which the next symbol Sᵢ₊₁ is assigned. Table 1 provides an illustrative example of symbols in a predefined set of 8 symbols being assigned to frequency bands without regard to any particular ordering of the symbols.

TABLE 1

| Frequency Band (MHz) | Nominal Frequency (MHz) | Symbol |
|---|---|---|
| 4.7-4.9 | 4.8 | S₂ |
| 9.1-9.3 | 9.2 | S₃ |
| 10.6-10.8 | 10.7 | S₇ |
| 11.4-11.6 | 11.5 | S₀ |
| 11.7-11.9 | 11.8 | S₅ |
| 14.7-14.9 | 14.8 | S₁ |
| 18.5-18.7 | 18.6 | S₄ |
| 20.0-20.2 | 20.1 | S₆ |

In some embodiments, instead of assigning frequencies or frequency bands to symbols, lookup tables 104-1 and 124-1 assign frequency differences (sometimes called frequency shifts) to symbols. In some embodiments, the difference in frequency between a respective signal pulse and a most-recent prior signal pulse (e.g., with no intervening signal pulses) is used to represent a symbol. In some embodiments, a transmitting system prepares to transmit a first symbol by determining, using a lookup table, a first frequency difference associated with the first symbol. In some embodiments, the transmitting system then transmits the first signal by transmitting a first signal pulse at a first frequency, and a second signal pulse at a second frequency, where the difference between the second frequency and the first frequency (or the absolute value of the difference) is the first frequency difference. In some embodiments, a receiving system receives a first signal pulse and determines a first frequency of the first signal pulse, and then receives a second signal pulse and determines a second frequency of the second signal pulse, where the difference between the second frequency and the first frequency (or the absolute value of the difference) is a respective frequency difference. In some embodiments, the receiving system determines, using a lookup table, the symbol corresponding to the determined frequency difference. It is noted that where frequency differences are used to represent symbols instead of frequencies, the frequency bands used to transmit signal pulses may or may not be contiguous, and may be widely separated rather than confined to a narrow frequency range.

FIG. 3C is a conceptual diagram showing example allocations of a frequency spectrum 300, in accordance with some embodiments. Frequency spectrum 300 includes a set of frequency bands associated with a predefined set of N symbols S₀ through S_{N-1}. Each respective symbol in the predefined set is associated with a distinct frequency band in the set of frequency bands in frequency spectrum 300. For example, as shown in FIG. 3C, frequency spectrum 300 includes non-contiguous frequency bands 302, 304, 306, 308, 310, and 312. Frequency band 302 is associated with (e.g., represents) symbol S₀; frequency band 304 is associated with symbol S₁; frequency band 306 is associated with symbol S₂; frequency band 308 is associated with symbol S₃; frequency band 310 is associated with symbol S₄; and frequency band 312 is associated with symbol S_{N-1}. The set of frequency bands (which includes frequency bands 302, 304, 306, 308, 310, and 312) associated with the predefined set of N symbols, in aggregate, are not contiguous.

FIG. 3D illustrates an example sequence 320 of discrete-frequency signals, in accordance with some embodiments. In some embodiments, sequence 320 is transmitted by a transmitting system (e.g., transmitting system 120, FIG. 1, or transmitting system 200, FIG. 2A) or a component of a transmitting system (e.g., transmitter 114, FIG. 1). In some embodiments, sequence 320 is received by a receiving system (e.g., receiving system 140, FIG. 1, or receiving system 220, FIG. 2B) or a component of a receiving system (e.g., receiver 118, FIG. 1). Each signal pulse in the sequence represents a respective symbol of the predefined set of N symbols based on the frequency of the signal pulse. For example, sequence 320 includes a first signal pulse 322 at a first frequency that represents symbol S₂, followed by a second signal pulse 324 at a second frequency that represents symbol S₄, followed by a third signal pulse 326 at a third frequency that represents symbol S₀, followed by a fourth signal pulse 328 at a fourth frequency that represents symbol S₃. Sequence 320 optionally includes one or more additional signal pulses at respective frequencies representing respective symbols in the predefined set of symbols.

FIG. 3E illustrates example variations in signal properties (e.g., phase, amplitude, pulse width) for representing additional symbols using a given frequency (e.g., where the frequency represents a first symbol). That is, each signal pulse represents multiple symbols, the multiple symbols including a respective symbol from each of multiple distinct sets of symbols, where each set of symbols corresponds to a distinct signal property. In some embodiments, a first number of bits of information (e.g., corresponding to a first set of symbols) is represented by a first signal property (e.g., the frequency) of a given signal pulse. In some embodiments, a second number of bits of information (e.g., corresponding to a second set of symbols) is represented by another signal property (e.g., in addition to the frequency) of a signal pulse at the particular frequency. For example, FIG. 3E illustrates four signal pulses 330, 332, 334, and 336. Signal pulse 330 has a frequency that represents a symbol S₁, selected from a first set of symbols (e.g., the set of symbols S₀ to S_{N-1}, shown in lookup tables 104-1 and 124-1). In addition, in the example shown in FIG. 3E, signal pulse 330 represents the information of symbol S₁ in combination with the information of symbol T₁ (e.g., selected from a set of symbols, T, corresponding to the phase of the signal), the information of symbol U₁ (e.g., selected from a set of symbols U, corresponding to the amplitude of the signal), and the information of symbol V₁ (e.g., selected from a set of symbols V₀ to V_{M-1}, shown in lookup tables 104-y and 124-y, corresponding to the pulse duration). In some embodiments, only a subset of the signal properties of a signal or signal pulse correspond to symbols and corresponding bits of information. For example, the signal carries information using the frequency (e.g., and associated symbol Sᵢ) of the signal and the pulse duration (e.g., and associated symbol Vᵢ) of the signal, while the other signal properties, such as amplitude and phase, do not represent additional information.

Signal pulse 332 (represented by the solid line under the reference number 332 in FIG. 3E) has the same frequency as signal pulse 330 and thus is also associated with symbol S₁. Signal pulse 332 also has the same amplitude (e.g., associated with symbol U₁) and pulse width (e.g., associated with symbol V₁) as signal pulse 330. However, signal pulse 332 is shifted in phase relative to signal pulse 330 (indicated by the dotted line under the reference number 332), as indicated by the offset between the solid line and the dotted line. Thus, signal pulse 332 has a different phase from signal pulse 330, and the phase of signal pulse 332 represents a different symbol than the phase of pulse 330. Specifically, the phase of signal pulse 332 corresponds to symbol T₂ (e.g., as determined using a lookup table storing data values corresponding to the set of symbols, T, that represent the signal property of phase) instead of symbol T₁. The symbol T₁, associated with signal pulse 330, is from the same set of symbols as the symbol T₂ (e.g., the set of symbols, T, corresponding to the signal property of phase). As such, signal pulse 332 represents the information of symbols S₁, U₁, and V₁ in combination with bits of information that correspond to the symbol T₂. Lookup table(s) 104 and 124 are used to identify the value of the respective signal property that is associated with the respective symbol.

Signal pulse 334 has the same frequency as signal pulses 330 and 332 and thus is also associated with the symbol S₁. Signal pulse 334 also has the same phase as signal pulses 330 and 332 and thus is also associated with symbol T₁. In addition, signal pulse 334 has the same pulse width as signal pulses 330 and 332 and thus is also associated with symbol V₁. However, signal pulse 334 has a different amplitude (e.g., corresponding to symbol U₂) than signal pulses 330 and 332 (e.g., which have amplitudes corresponding to symbol U₁). As such, signal pulse 334 represents the information of symbol S₁, the information of symbol T₁, and the information of symbol V₁, in combination with the bits of information associated with symbol U₂ (e.g., as determined using a lookup table storing data values corresponding to the set of symbols U that represent the signal property of amplitude).

Finally, signal pulse 336 has the same frequency as signal pulses 330, 332, and 334, and thus is also associated with the symbol S₁. Signal pulse 336 also has the same phase (e.g., associated with symbol T₁) and amplitude (e.g., associated with symbol U₁) as signal pulses 330, 332, and 334. However, the pulse duration of signal pulse 336 is different from the pulse durations of signals 330, 332, and 334, and corresponds to a different symbol V₂. As such, signal pulse 336 represents the information of symbol S₁, the information of symbol T₁, and the information of symbol U₁ in combination with bits of information associated with symbol V₂.

Although FIG. 3E illustrates two different symbols for each signal property represented by signals 330, 332, 334, and 336 (e.g., symbols S₁ and S₂ associated with frequency, symbols T₁ and T₂ associated with phase, symbols U₁ and U₂ associated with amplitude, and symbols V₁ and V₂ associated with pulse duration), one of ordinary skill in the art will readily appreciate that any number (e.g., three, four, eight, or any other number) of variations in a respective signal property can be used to represent any number (e.g., three, four, eight, or any other number, respectively) of symbols associated with the respective signal property. In addition, one of ordinary skill in the art will readily appreciate that any number of different signal properties can be used to represent additional information beyond the symbol represented by the signal frequency. As such, the transmitting and receiving systems can use a plurality of signal properties of a same signal pulse to communicate information between the transmitting system and the receiving system. For example, each signal property, such as frequency, phase, amplitude, and pulse width, is associated with a distinct set of symbols (e.g., symbol sets S, T, U, and V, respectively). The set(s) of symbols may be stored in lookup table(s) to associate data with different values of a respective signal property.

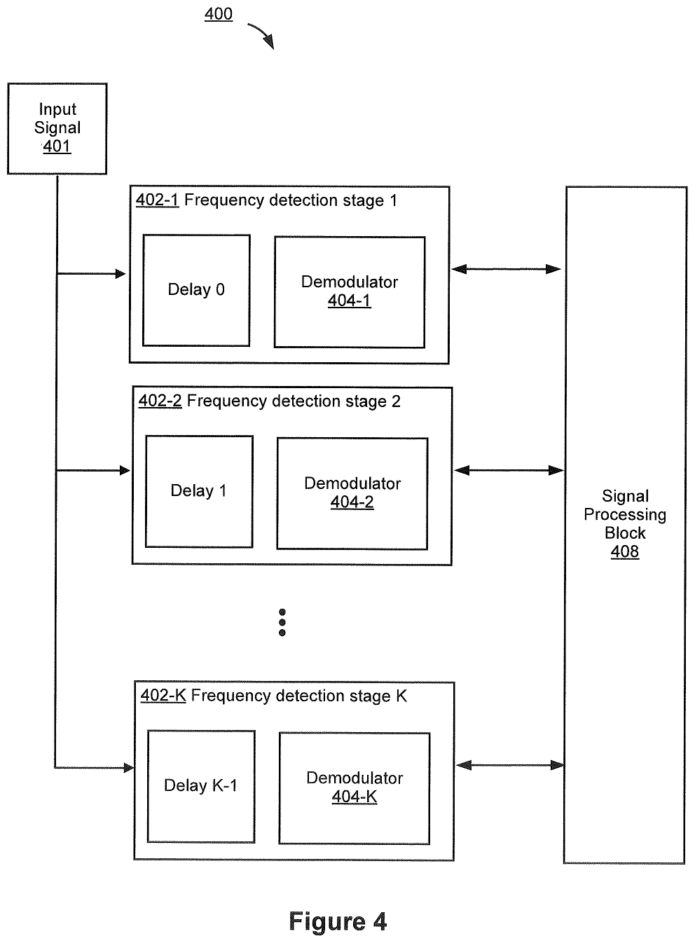

FIG. 4 is a block diagram illustrating an example implementation of frequency detection circuitry 400, in accordance with some embodiments. In some embodiments, frequency detection circuitry 400 corresponds to, or is part of, frequency determination circuitry 116 (FIG. 1), or frequency detector 128 (FIG. 1). In some embodiments, frequency detection circuitry 400 is used to detect the frequency of an input signal 401. In some embodiments, frequency detection circuitry includes one or more frequency detection stages 402.

Input signal 401 is received at a first frequency detection stage 402-1. In some embodiments, no delay (e.g., a delay of zero) is applied to input signal 401 upon being received at frequency detection stage 402-1. In some embodiments, demodulator 404-1 in first frequency detection stage 402-1 compares received input signal 401 to respective frequencies in a plurality of candidate frequency bands (or frequency ranges). Demodulator 404-1 determines a particular first frequency band of the candidate frequency bands that has the greatest degree of correlation with input signal 401. The determined frequency first band is interpreted to be the frequency band in which the frequency of the received input signal 401 must exist. In some embodiments, the results of frequency detection stage 402-1 (e.g., the outputs of demodulator 404-1) are provided to a signal processing block 408.

In some embodiments, input signal 401 is provided to second frequency detection stage 404-2, which delays input signal 401 (e.g., with a first amount of delay). The delayed input signal is provided to second demodulator 404-2. In some embodiments, the determined first frequency band from demodulator 404-1 is subdivided into a second plurality of (narrower) candidate frequency bands. In some embodiments, signal processing block 408 receives the identification of the first frequency band from frequency detection stage 402-1, determines the subdivisions, and configures frequency detection stage 402-2 (or a component of frequency detection stage 402-2, such as demodulator 404-2) using the second plurality of candidate frequency bands. In some embodiments, second demodulator 404-2 compares the delayed input signal to respective frequencies in the second plurality of candidate frequency bands (e.g., the subdivisions of the determined first frequency band from frequency detection stage 402-1). Second demodulator 404-2 determines a particular second frequency band (narrower than the first frequency band) of the second plurality of candidate frequency bands that has the greatest degree of correlation with the delayed input signal. The determined second frequency band is interpreted to be the frequency band in which the frequency of the received input signal 401 must exist.

One of ordinary skill will readily appreciate that any number K of frequency detection stages (e.g., up to and including frequency detection stage 402-K) are used to determine the frequency of input signal 401 with increasingly greater accuracy, through successive delays of input signal 401 and successive subdivision of frequency bands determined by preceding stages into narrower candidate frequency bands, and comparison of the delayed input signals to the increasingly narrower candidate frequency bands (e.g., by demodulators up to and including demodulator 404-K). In some embodiments, signal processing block 408 obtains the identified frequency band of each preceding stage and uses the identified frequency band to configure each successive frequency detection stage with the narrowed set of candidate frequency bands based on the identified frequency band.

In some embodiments, delays for successive frequency detection stages increase linearly. In some embodiments, delays for successive frequency detection stages increase exponentially by a predefined multiple. For example, a first stage applies zero delay; a second stage applies a first amount of delay; a third stage applies a second amount of delay that is a predefined multiple K of the first amount of delay; a fourth stage applies a third amount of delay that is K² times the first amount of delay, etc.

FIGS. 5A-5C are flow diagrams illustrating an example method 500 of receiving information, in accordance with some embodiments. In some embodiments, and as described herein, method 500 is performed at a system for information transfer (e.g., receiving system 140, FIG. 1, or receiving system 220, FIG. 2B). In some embodiments, the system includes a receiver (e.g., receiver 118, FIG. 1), frequency discrimination circuitry (e.g., frequency determination circuitry 116, FIG. 1), and processing circuitry (e.g., processing circuitry 122, FIG. 1). In some embodiments, the processing circuitry is implemented using one or more processors (e.g., CPU(s) 222, FIG. 2B), and memory (e.g., memory 226, FIG. 2B) storing one or more programs for execution by the one or more processors, the one or more programs including instructions for performing operations described herein. In some embodiments, the processing circuitry is implemented using hardware circuitry such as one or more field-programmable gate arrays (FPGAs) or application-specific integrated circuits (ASICs) configured to perform the operations described herein. In some embodiments, the system includes or is electrically coupled with one or more lookup tables (e.g., lookup table(s) 124-1 and/or 124-y). In some embodiments, the one or more lookup tables include a lookup table (e.g., lookup table 124-1, FIG. 3B) storing a (first) predefined set of frequencies and/or frequency bands and a predefined set of first data (e.g., bit patterns representing data), where each frequency is associated with a respective data value. In some embodiments, the one or more lookup tables include a lookup table (e.g., lookup table 124-y, FIG. 3B) storing a predefined set of signal property values (e.g., the signal property represents amplitude, phase, and/or pulse duration) and a predefined set of second data (e.g., bit patterns representing data), where each signal property value is associated with a respective second data value. For example, FIG. 3B illustrates lookup table 124-y for storing values of pulse duration, each value of the pulse duration associated with a symbol from symbol set V and/or a data value (e.g., from 0 to M−1).

In some embodiments, at the system for information transfer (502), the system receives (504) a first signal pulse. The first signal pulse represents (506) first data and second data (e.g., represented by a first symbol from a first set of symbols, S, and a second symbol from a second set of symbols, V, FIG. 3B). In some embodiments, the first data and the second data correspond (508) to bits of data (e.g., the data values shown in the lookup tables of FIGS. 3A and 3B).

The system determines (510) a first frequency band that is associated with the first signal pulse. The system determines (512) a first value of a first signal property (e.g., other than the frequency) that is associated with the first signal pulse. In some embodiments, the first signal property is (514) phase. In some embodiments, the first signal property is (516) amplitude. In some embodiments, the first signal property is (518) pulse width.

In accordance with a determination that the first frequency band is a respective frequency band in a first predefined set of frequency bands, the system determines (520) first data, from a first set of data, that is associated with the first frequency band and represented by the first signal pulse. For example, the system determines that the first signal pulse has a first frequency of 10.294 MHz (or that the first signal pulse has a frequency that is in or associated with the frequency band centered on 10.294 MHz) and determines (e.g., using lookup table 124-1) that the frequency is associated with symbol S₁ and the first data corresponds to the data value 0001. Each frequency band in the predefined set of frequency bands is associated (522) with distinct respective data from the first set of data. The first predefined set of frequency bands, in aggregate, are (524) not contiguous.

In accordance with a determination that the first value of the first signal property is a respective value in a first predefined set of values of the first signal property, the system determines (526) second data, from a second set of data, that is associated with the first value of the first signal property and represented by the first signal pulse. For example, the system determines that the first signal pulse has a first signal property (e.g., pulse duration) of 5.634 ns and determines (e.g., using lookup table 124-y) the pulse duration is associated with symbol V₄ and the first data corresponds to the data value 100.

Each value of the first signal property in the first predefined set of values of the first signal property is associated (528) with distinct respective data from the second set of data. For example, lookup table 124-y illustrates that the each value of pulse duration corresponds to a distinct symbol, Vᵢ, and a distinct data value.

In some embodiments, the first set of data and the second set of data correspond (530) to respective portions of a same predefined set of symbols. In other words, a respective data value corresponding to a respective symbol in the predefined set of symbols includes a first subset of bits provided by a data value from the first set of data and a second subset of bits provided by a data value in the second set of data. For example, the data values in lookup table 124-1 are four bits (e.g., the lower four bits) of each respective symbol in a set of symbols W, and the data values in lookup table 124-y are three other bits (e.g., the upper three bits) of each respective symbol in symbol set W. In some embodiments, the first subset of bits and the second subset of bits within each respective symbol do not overlap (e.g., each symbol W includes seven bits such that the upper three bits do not overlap with the lower four bits).

In some embodiments, the first set of data corresponds (532) to a first set of symbols and the second set of data corresponds to a second set of symbols distinct from the first set of symbols. For example, the first set of data (e.g., 0000 to N−1, lookup table 124-1, FIG. 3B) corresponds to a first set of symbols S, and the second set of data (e.g., 000 to M−1, lookup table 124-y, FIG. 3B) corresponds to a second set of symbols V. The set of symbols S is distinct from the set of symbols V.

In some embodiments, each respective data in the first set of data is (536) associated with only one respective frequency band in the first predefined set of frequency bands, and each respective data in the second set of data is associated with only one respective value in the first predefined set of values of the first signal property.

In some embodiments, the system determines (538) a value of a second signal property that is associated with the first signal pulse.

In some embodiments, in accordance with a determination that the value of the second signal property is a respective value in a second predefined set of values of the second signal property, the system determines (540) third data, from a third set of data, that is associated with the value of the second signal property and represented by the first signal pulse. For example, as described with reference to FIG. 3E, third data (represented by the set of symbols T) is associated with the signal property of phase. In some embodiments, each value of the second signal property in the second predefined set of values of the second signal property is (542) associated with distinct respective data from the third set of data.

In some embodiments, the system determines (544) a value of a third signal property that is associated with the first signal pulse.

In some embodiments, in accordance with a determination that the value of the third signal property is a respective value in a third predefined set of values of the third signal property, the system determines (546) fourth data, from a fourth set of data, that is associated with the value of the third signal property and represented by the first signal pulse. For example, as described with reference to FIG. 3E, fourth data (represented by the set of symbols U) is associated with the signal property amplitude. In some embodiments, each value of the third signal property in the third predefined set of values of the third signal property is (548) associated with distinct respective data from the fourth set of data.

In some embodiments, the first signal property, the second signal property and the third signal property are (550) distinct signal properties.

In some embodiments, after at least a predefined amount of time since receiving the first signal pulse, the system receives (552) a second signal pulse. For example, as described with reference to FIG. 3D, a sequence of discrete-frequency signals may include a first signal pulse 322 followed by a second signal pulse 324. In another example, a sequence of discrete-frequency signals may include a first signal pulse 330 (FIG. 3E) followed by a second signal pulse 332 (FIG. 3E). In some embodiments, the system determines a second frequency band that is associated with the second signal pulse and determining a second value of the first signal property that is associated with the second signal pulse. In some embodiments, in accordance with a determination that the second frequency band is the respective frequency band in the first predefined set of frequency bands, the system determines fifth data, from the first set of data, that is associated with the second frequency band and represented by the second signal pulse. The fifth data is the same as the first data. In some embodiments, in accordance with a determination that the second value of the first signal property is a respective value in the first predefined set of values of the first signal property, the system determines sixth data, from the second set of data, that is associated with the second value of the first signal property and represented by the second signal pulse, wherein the sixth data is distinct from the second data. For example, as explained with reference to FIG. 3E, the first data represented by the frequency of a first signal pulse 330, corresponding to symbol S₁, is the same as the fifth data represented by the frequency of a second signal pulse 332, corresponding to symbol S₁. However, first signal pulse 330 has a first phase value that represents second data corresponding to symbol T₁, and second signal pulse 332 has a second phase value, different from the first phase value, that represents sixth data corresponding to symbol T₂, where the second data, T₁, is distinct from the sixth data, T₂.

It should be understood that the particular order in which the operations in method 500 have been described is merely an example and is not intended to indicate that the described order is the only order in which the operations could be performed. One of ordinary skill in the art would recognize various ways to re-order the operations described herein. Additionally, it should be noted that details of other processes described herein with respect to other methods described herein (e.g., method 600) are also applicable in an analogous manner to method 500 described above with respect to FIGS. 5A-5C. For example, the signal pulses, symbols, units of data, frequencies, and frequency bands described above with reference to method 500 optionally have one or more of the characteristics of the signal pulses, symbols, units of data, frequencies, and frequency bands described herein with reference to other methods described herein (e.g., method 600). For brevity, these details are not repeated here.

FIGS. 6A-6C are flow diagrams illustrating an example method 600 of transmitting information, in accordance with some embodiments. In some embodiments, and as described herein, method 600 is performed at a system for information transfer (e.g., transmitting system 120, FIG. 1, or transmitting system 200, FIG. 2A). In some embodiments, the system includes a transmitter (e.g., transmitter 114, FIG. 1), frequency generation circuitry (e.g., frequency generation circuitry 106, FIG. 1), and processing circuitry (e.g., processing circuitry 102, FIG. 1). In some embodiments, the processing circuitry is implemented using one or more processors (e.g., CPU(s) 202, FIG. 2A), and memory (e.g., memory 206, FIG. 2A) storing one or more programs for execution by the one or more processors, the one or more programs including instructions for performing operations described herein. In some embodiments, the processing circuitry is implemented using hardware circuitry such as one or more field-programmable gate arrays (FPGAs) or application-specific integrated circuits (ASICs) configured to perform the operations described herein. In some embodiments, the system includes or is electrically coupled with one or more lookup tables (e.g., lookup table(s) 104-1 and/or 104-y, FIG. 3A).

At the system for information transfer (602), the system obtains (604) first data, (e.g., a symbol) from a first set of data, (e.g., first symbol data) and second data (e.g., a second symbol), from a second set of data (e.g., second symbol data), for transmission. For example, the system obtains first data 0010 (represented by symbol S₂, FIG. 3A) and second data 011 (represented by symbol V₃, FIG. 3A). In some embodiments, the first data and the second data correspond (606) to bits of data.

In some embodiments, the first set of data and the second set of data correspond (608) to respective (e.g., adjoining) portions of a same predefined set of symbols. For example, the data values in lookup table 104-1 are a first subset of bits of each respective data value for the predefined set of symbols, and the data values in lookup table 104-y are a second subset of bits of each respective data value for the same predefined set of symbols. In some embodiments, the first set of data provides a first portion (e.g., a first subset of bits, such as the lowermost bits) of each symbol in the predefined set of symbols. In some embodiments, the second set of data provides a second portion (e.g., a second subset of bits, such as the uppermost bits) of each symbol in the predefined set of symbols (e.g., without any overlap in bits between the first portion and the second portion). In some embodiments where another signal property is used to represent a third set of data, the third set of data provides a third portion of each symbol in the predefined set of symbols (e.g., a third subset of bits, in some embodiments not overlapping with any of the bits provided by the first and second sets of data).

In some embodiments, the first set of data corresponds (610) to a first set of symbols and the second set of data corresponds to a second set of symbols distinct from the first set of symbols. For example, the set of symbols S in lookup table 104-1 (FIG. 3A) is distinct from the set of symbols V in lookup table 104-y (FIG. 3A).

The system determines (612) a first frequency band, in a first predefined set of frequency bands, that is associated with the first data. For example, first data 0010 represented by symbol S₂ corresponds to frequency 10.356 MHz (or to the frequency band centered on 10.356 MHz). Each frequency band in the first predefined set of frequency bands is (614) associated with distinct respective data from the first set of data. The first predefined set of frequency bands, in aggregate, are (616) not contiguous.

The system determines (618) a first value of a first signal property (e.g., phase, amplitude, pulse width, etc.), in a first predefined set of values of the first signal property (e.g., a predefined set of phase values, a predefined set of amplitudes, a predefined set of pulse widths, etc.), that is associated with the second data. For example, the system determines, based on the second data 011 (represented by V₃), that the first value of pulse duration is 5.596 ns. Each value of the first signal property in the first predefined set of values of the first signal property is (620) associated with distinct respective data from the second set of data. For example, as shown in lookup table 104-y, each value of pulse duration is associated with a distinct respective symbol in the symbol set V and a corresponding respective data value.

In some embodiments, the first signal property is (622) phase. In some embodiments, the predefined set of values of the first signal property is a predefined set of distinct phase values.

In some embodiments, the first signal property is (624) amplitude. In some embodiments, the predefined set of values of the first signal property is a predefined set of distinct amplitudes.

In some embodiments, the first signal property is (626) pulse width (e.g., pulse duration, as shown in lookup table 104-y, FIG. 3A). In some embodiments, the predefined set of values of the first signal property is a predefined set of distinct pulse widths or pulse durations.

In some embodiments, each respective data in the first set of data is (628) associated with only one respective frequency band in the first predefined set of frequency bands, and each respective data in the second set of data is associated with only one respective value in the first predefined set of values of the first signal property. For example, as shown in FIG. 3A, each frequency in lookup table 104-1 is associated with one symbol and one data value. Each pulse duration in lookup table 104-y is associated with one symbol and one data value.

The system transmits (630) a first signal pulse having a first frequency in the first frequency band and having the first value of the first signal property. The first signal pulse represents (632) the first data and the second data.

In some embodiments, the system obtains (634) third data from a third set of data and determining a first value of a second signal property (e.g., phase, amplitude, pulse width, etc.) (e.g., distinct from the first signal property), in a second predefined set of values of the second signal property (e.g., a predefined set of phase values, a predefined set of amplitudes, a predefined set of pulse widths, etc.), that is associated with the third data. In some embodiments, the transmitted first signal pulse has the first value of the second signal property. In some embodiments, each value of the second signal property in the second predefined set of values of the second signal property is associated with distinct respective data from the third set of data.

In some embodiments, the system obtains (636) fourth data from a fourth set of data and determining a first value of a third signal property (e.g., phase, amplitude, pulse width, etc.) (e.g., distinct from the first signal property and the second signal property) in a third predefined set of values of the third signal property, that is associated with the fourth data. In some embodiments, the transmitted first signal pulse has the first value of the third signal property. In some embodiments, each value of the third signal property in the third predefined set of values of the third signal property is associated with distinct respective data from the fourth set of data.

In some embodiments, the first signal property, the second signal property and the third signal property are (638) distinct signal properties. In some embodiments, the second signal property is phase, amplitude or pulse width. In some embodiments, the third signal property is phase, amplitude or pulse width. For example, the first signal pulse represents a frequency (e.g., first data) and one or more signal properties, including a phase (e.g., second data), an amplitude (e.g., third data) and/or a pulse width (e.g., fourth data). For example, as explained with reference to FIG. 3E, the first signal pulse 330 has a frequency, phase, amplitude and/or pulse width, each of these signal properties representing data (e.g., corresponding to symbols S, T, U and V, respectively).

In some embodiments, the system obtains (640) fifth data from the first set of data and sixth data from the second set of data for transmission. The fifth data is the same as the first data and the sixth data is distinct from the second data. For example, as explained with reference to FIG. 3E, the second signal pulse 332 has a different phase, represented by symbol T₂, than the first signal pulse 330 (with a phase represented by symbol T₁). The first signal pulse 330 and the second signal pulse 332 have the same frequency represented by the symbol S₁. The system determines a second frequency band, in the first predefined set of frequency bands, that is associated with the fifth data. The second frequency band is the same as the first frequency band. The system determines a second value of the first signal property, in the first predefined set of values of the first signal property, that is associated with the sixth data. The second value of the first signal property is distinct from the first value of the first signal property. In some embodiments, after at least a predefined amount of time since transmitting the first signal pulse, the system transmits a second signal pulse having the second value of the first signal property and having a respective frequency in the first frequency band.

It should be understood that the particular order in which the operations in method 600 have been described is merely an example and is not intended to indicate that the described order is the only order in which the operations could be performed. One of ordinary skill in the art would recognize various ways to re-order the operations described herein. Additionally, it should be noted that details of other processes described herein with respect to other methods described herein (e.g., method 500) are also applicable in an analogous manner to method 600 described above with respect to FIGS. 6A-6C. For example, the signal pulses, symbols, units of data, frequencies, and frequency bands described above with reference to method 600 optionally have one or more of the characteristics of the signal pulses, symbols, units of data, frequencies, and frequency bands described herein with reference to other methods described herein (e.g., method 500). For brevity, these details are not repeated here.

The foregoing description, for purpose of explanation, has been described with reference to specific embodiments. However, the illustrative discussions above are offered by way of example only, and are not intended to be exhaustive or to limit the invention to the precise forms disclosed. Many modifications and variations are possible in view of the above teachings without departing from their spirit and scope, as will be apparent to those skilled in the art. The embodiments were chosen and described in order to best explain the principles of the invention and its practical applications, to thereby enable others skilled in the art to best use the invention and various embodiments with various modifications as are suited to the particular use contemplated.

What is claimed is:

1. A method of transmitting information, comprising:
obtaining first data, from a first set of data, and second data, from a second set of data, for transmission;
determining a first frequency band, in a first predefined set of frequency bands, that is associated with the first data;
determining a first value of a first signal property, in a first predefined set of values of the first signal property, that is associated with the second data; and
transmitting a first signal pulse having a first frequency in the first frequency band and having the first value of the first signal property;
wherein:
the first signal pulse represents the first data and the second data;
each frequency band in the first predefined set of frequency bands is associated with distinct respective data from the first set of data;
each value of the first signal property in the first predefined set of values of the first signal property is associated with distinct respective data from the second set of data; and
the first predefined set of frequency bands, in aggregate, are not contiguous.

2. The method of claim 1, wherein the first data and the second data correspond to bits of data.

3. The method of claim 1, wherein the first set of data and the second set of data correspond to respective portions of a same predefined set of symbols.

4. The method of claim 1, wherein the first set of data corresponds to a first set of symbols and the second set of data corresponds to a second set of symbols distinct from the first set of symbols.

5. The method of claim 1, wherein the first signal property is phase.

6. The method of claim 1, wherein the first signal property is amplitude.

7. The method of claim 1, wherein the first signal property is pulse width.

8. The method of claim 1, further comprising:
obtaining third data from a third set of data;
determining a first value of a second signal property, in a second predefined set of values of the second signal property, that is associated with the third data;
wherein:
the transmitted first signal pulse has the first value of the second signal property; and
each value of the second signal property in the second predefined set of values of the second signal property is associated with distinct respective data from the third set of data.

9. The method of claim 8, further comprising:
obtaining fourth data from a fourth set of data;
determining a first value of a third signal property in a third predefined set of values of the third signal property, that is associated with the fourth data;
wherein:
the transmitted first signal pulse has the first value of the third signal property; and
each value of the third signal property in the third predefined set of values of the third signal property is associated with distinct respective data from the fourth set of data.

10. The method of claim 9, wherein the first signal property, the second signal property and the third signal property are distinct signal properties.

11. The method of claim 1, wherein each respective data in the first set of data is associated with only one respective frequency band in the first predefined set of frequency bands, and each respective data in the second set of data is associated with only one respective value in the first predefined set of values of the first signal property.

12. The method of claim 1, further comprising:
obtaining fifth data from the first set of data and sixth data from the second set of data for transmission, wherein the fifth data is the same as the first data and the sixth data is distinct from the second data;
determining a second frequency band, in the first predefined set of frequency bands, that is associated with the fifth data, wherein the second frequency band is the same as the first frequency band;
determining a second value of the first signal property, in the first predefined set of values of the first signal property, that is associated with the sixth data, wherein the second value of the first signal property is distinct from the first value of the first signal property; and
after at least a predefined amount of time since transmitting the first signal pulse, transmitting a second signal pulse having the second value of the first signal property and having a respective frequency in the first frequency band.

13. A system for information transfer, comprising:
processing circuitry, configured to:
obtain first data from a first set of data and second data from a second set of data for transmission;
determine a first frequency band, in a first predefined set of frequency bands, that is associated with the first data; and
determine a first value of a first signal property, in a first predefined set of values of the first signal property, that is associated with the second data; and
a transmitter, configured to transmit a first signal pulse having a first frequency in the first frequency band and having the first value of the first signal property;
wherein:
the first signal pulse represents the first data and the second data;
each frequency band in the predefined set of frequency bands is associated with distinct respective data from the first set of data;
each value of the first signal property in the first predefined set of values of the first signal property is associated with distinct respective data from the second set of data; and
the predefined set of frequency bands, in aggregate, are not contiguous.

14. A method of receiving information, comprising:
receiving a first signal pulse;
determining a first frequency band that is associated with the first signal pulse;
determining a first value of a first signal property that is associated with the first signal pulse;
in accordance with a determination that the first frequency band is a respective frequency band in a first predefined set of frequency bands:
determining first data, from a first set of data, that is associated with the first frequency band and represented by the first signal pulse; and
in accordance with a determination that the first value of the first signal property is a respective value in a first predefined set of values of the first signal property:
determining second data, from a second set of data, that is associated with the first value of the first signal property and represented by the first signal pulse;
wherein:
the first signal pulse represents the first data and the second data;
each frequency band in the predefined set of frequency bands is associated with distinct respective data from the first set of data;
each value of the first signal property in the first predefined set of values of the first signal property is associated with distinct respective data from the second set of data; and
the first predefined set of frequency bands, in aggregate, are not contiguous.

15. The method of claim 14, wherein the first set of data corresponds to a first set of symbols and the second set of data corresponds to a second set of symbols distinct from the first set of symbols.

16. The method of claim 14, wherein the first signal property is phase.

17. The method of claim 14, further comprising:
determining a value of a second signal property that is associated with the first signal pulse;
in accordance with a determination that the value of the second signal property is a respective value in a second predefined set of values of the second signal property:
determining third data, from a third set of data, that is associated with the value of the second signal property and represented by the first signal pulse;
wherein:
each value of the second signal property in the second predefined set of values of the second signal property is associated with distinct respective data from the third set of data.

18. The method of claim 17, further comprising:
determining a value of a third signal property that is associated with the first signal pulse;
in accordance with a determination that the value of the third signal property is a respective value in a third predefined set of values of the third signal property:
determining fourth data, from a fourth set of data, that is associated with the value of the third signal property and represented by the first signal pulse;
wherein:
each value of the third signal property in the third predefined set of values of the third signal property is associated with distinct respective data from the fourth set of data.

19. The method of claim 14, further comprising:
after at least a predefined amount of time since receiving the first signal pulse, receiving a second signal pulse;
determining a second frequency band that is associated with the second signal pulse;
determining a second value of the first signal property that is associated with the second signal pulse;
in accordance with a determination that the second frequency band is the respective frequency band in the first predefined set of frequency bands:
determining fifth data, from the first set of data, that is associated with the second frequency band and represented by the second signal pulse, wherein the fifth data is the same as the first data; and
in accordance with a determination that the second value of the first signal property is a respective value in the first predefined set of values of the first signal property:
determining sixth data, from the second set of data, that is associated with the second value of the first signal property and represented by the second signal pulse, wherein the sixth data is distinct from the second data.

20. A system for information transfer, comprising:
a receiver, configured to receive a first signal pulse;
frequency determination circuitry, configured to determine a first frequency band that is associated with the first signal pulse;
first signal property determination circuitry, configured to determine a first value of a first signal property that is associated with the first signal pulse; and
processing circuitry, configured to:
in accordance with a determination that the first frequency band is a respective frequency band in a first predefined set of frequency bands:
determine first data, from a first set of data, that is associated with the first frequency band and represented by the first signal pulse; and
in accordance with a determination that the first value of the first signal property is a respective value in a first predefined set of values of the first signal property:
determine second data, from a second set of data, that is associated with the first value of the first signal property and represented by the first signal pulse;
wherein:
the first signal pulse represents the first data and the second data;
each frequency band in the predefined set of frequency bands is associated with distinct respective data from the first set of data;
each value of the first signal property in the first predefined set of values of the first signal property is associated with distinct respective data from the second set of data; and
the predefined set of frequency bands, in aggregate, are not contiguous.
